(19) United States
(12) Patent Application Publication
(10) Pub. No.: US 2006/0045717 A1
(43) Pub. Date: Mar. 2, 2006

(54) Retrofitted grapple saw and method for retrofitting hydraulic devices

(76) Inventor: Kerry Richard Seymour, Perry, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/136,739

(22) Filed: May 24, 2005

Related U.S. Application Data
(60) Provisional application No. 60/573,792, filed on May 24, 2004.

(51) Int. Cl. B66C 3/00

(52) U.S. Cl. 414/729

(57) ABSTRACT

Techniques for retrofitting a hydraulic grapple saw or other hydraulic device to a hydraulic boom arm with grapple or other existing hydraulic device. T-joints are inserted into the infeed and outfeed hydraulic fluid lines in the existing device so that secondary hydraulic lines may connect the T-joint to the grapple saw. Alternatively, a valve connects the infeed and outfeed of the boom arm and the infeed and outfeed of the grapple saw, or T-joints with built-in valves are used. The valves are toggled between open and closed positions by a control unit that sends a signal to the valves either by wire or wirelessly.

### RELATED APPLICATIONS

This non-provisional application claims the benefit of U.S. Provisional Application Ser. No. 60/573,792, filed May 24, 2004 and entitled “Retrofitted Grapple Saw and Method for Retrofitting Hydraulic Devices,” the entire contents of which are incorporated by this reference.

### FIELD OF THE INVENTION

The present invention relates to a retrofitted hydraulic device and a method for retrofitting a hydraulic device, and more particularly a retrofitted grapple saw.

### BACKGROUND

Hydraulic machinery, including boom arms, boom arms with grapples, actuating pistons, hydraulically powered motors, and other such devices, are commonly used throughout the logging industry and other industries. These devices require a number of hydraulic lines connecting the hydraulic device, such as a piston, to the hydraulic fluid pump. Because of limitations on placement of the pump and piston, hydraulic machinery generally has quite a complex network of hydraulic lines. Due to this complexity it is often difficult, expensive, or even impossible to retrofit an existing hydraulic machine with additional hydraulic components.

Furthermore, if an additional hydraulic component can be added to the system, the hydraulic lines that connect the additional component typically run from the hydraulic pump to the additional component. This usually requires lines of great length, further exacerbating the complexity of the network of hydraulic lines.

In addition, known systems having multiple hydraulic components do not have the ability to lock fluid into one hydraulic component while providing fluid to another component. Therefore, only one of the multiple hydraulic devices is operable at any given time.

Therefore, there is a need for an apparatus and method for retrofitting an additional hydraulic component to an existing hydraulic system while minimizing the hydraulic line length. Furthermore, there is a need for a system that allows the fluid in one hydraulic component to be locked in place, maintaining the pressure to that component, while also providing fluid to another hydraulic component.

### SUMMARY OF THE INVENTION

This invention is a secondary hydraulic device that may be added or retrofitted to an existing hydraulic device and a method for so retrofitting. The invention may be embodied in a variety of ways.

The retrofitted hydraulic device, for example a grapple saw, connects to an existing hydraulic device, for example a boom arm with grapple, at T-joints located in the existing hydraulic lines. Connecting the added device to the existing hydraulic lines, instead of connecting the secondary lines to the hydraulic reservoir and pump, requires shorter secondary lines.

The existing hydraulic device has a fluid reservoir and pump connected to a hydraulic device by a series of infeed hydraulic lines and outfeed hydraulic lines. In order to attach the secondary device to the existing device, T-joints are inserted into the existing hydraulic lines and secondary hydraulic lines are connected between the T-joints and the secondary device. Further, valves are inserted into the existing lines and into the secondary lines. The valves are each controlled by a control unit that sends signals to the valves either via electrical wires or wirelessly.

This invention may be better understood by reference to the description and figures that follow. The invention is not limited in its application to the specific details as set forth in the following description and figures. The invention is capable of other embodiments.

### BREIF DESCRIPTION OF THE DRAWINGS

These and other features, aspects, and advantages of this invention are better understood when the following Detailed Description is read with reference to the accompanying drawings, wherein:

FIG. 1 is a schematic diagram of an existing hydraulic system to which a secondary hydraulic device is to be attached.

FIG. 2 is a schematic diagram of a first embodiment of the present invention attached to the existing system of FIG. 1.

FIG. 3 is a schematic diagram of a second embodiment of the present invention attached to the existing system of FIG. 1.

FIG. 4 is a schematic diagram of a third embodiment of the present invention using wireless control attached to the existing system of FIG. 1.

FIG. 5 is a partially exploded perspective view of a boom grapple and grapple saw of this invention.

### DETAILED DESCRIPTION

Embodiments of the present invention include a hydraulic grapple saw retrofitted to another hydraulic device with relatively short hydraulic lines connecting the grapple saw to the hydraulic fluid reservoir and pump.

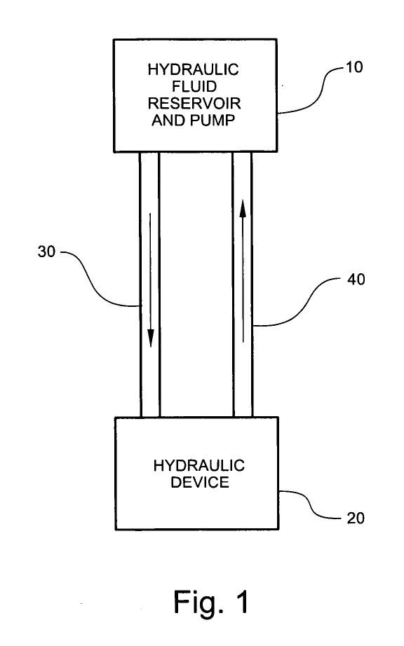

Hydraulic machinery is widely used. FIG. 1 shows the general configuration of a typical hydraulic device. A fluid reservoir and pump 10 are connected to a hydraulic device 20 via hydraulic lines 30, 40. Hydraulic fluid is pumped from the reservoir 10 through the infeed hydraulic line 30 to the hydraulic device 20. The hydraulic fluid returns from the device 20 to the reservoir 10 through the outfeed hydraulic line 40. Often, if a second hydraulic device is to be attached to the system, additional hydraulic lines must run the entire distance from the reservoir 10 to the second hydraulic device.

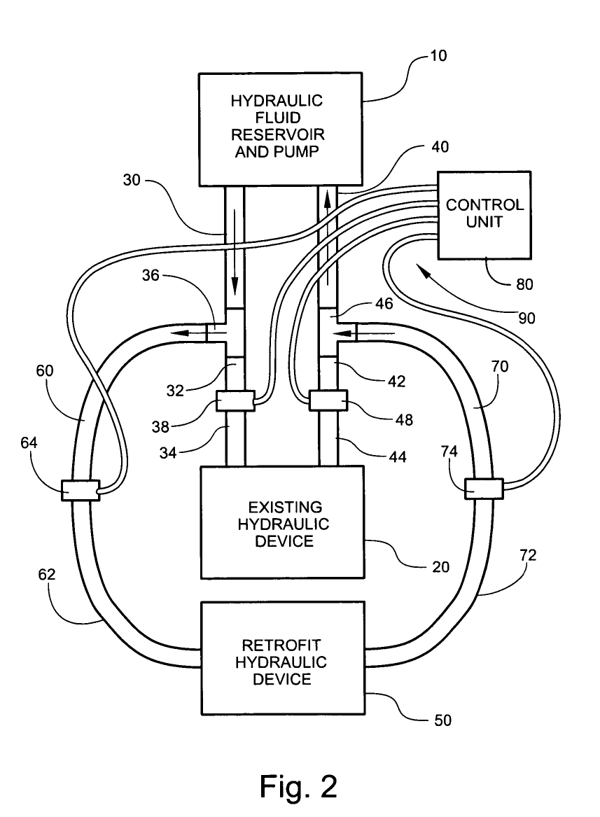

FIG. 2 is a schematic representation of an embodiment of this invention having hydraulic lines 62, 72 that supply fluid to and receive fluid from the second hydraulic device 50 that do not run the entire distance from the reservoir. Instead, the secondary hydraulic lines 60, 62 and 70, 72 are connected to the hydraulic lines 30, 32, 34 and 40, 42, 44 of the primary device 10 at junctions 36 and 46 relatively near the second hydraulic device 50. Moreover, the primary hydraulic lines 30, 32, 34 and 40, 42, 44 contain valves 38 and 48 that lock fluid in the lines to maintain hydraulic pressure in the primary device, even while additional fluid flows to the secondary device. In addition, the secondary hydraulic lines 60, 62 and 70, 72 contain valves 64 and 74 that allow or prevent flow to and from the secondary hydraulic device 50.

Specifically, the hydraulic fluid reservoir and pump 10 are connected to a primary hydraulic device 20 through a series of connected infeed lines 30, 32, 34 and a series of connected outfeed lines 40, 42, 44. If the user desires to attach a secondary hydraulic device 50, a T-coupling or T-joint 36 may be inserted between line 30 and line 32 and another T-joint 46 may be inserted between line 40 and line 42. Additionally, valve 38 may be inserted between line 32 and line 34 and valve 48 may be inserted between line 42 and line 44. Alternatively, the valves 38, 48 may already be in position in the hydraulic lines before the secondary hydraulic device 50 is attached. Further, the infeed to the secondary hydraulic device 50 is provided by a hydraulic line 60 connected to line 62 by a valve 64. Line 60 receives fluid from the fluid reservoir and pump 10 via the T-joint 36. Similarly, the outfeed from the secondary hydraulic device 50 is provided by a hydraulic line 70 connected to line 72 by a valve 74. Line 70 returns fluid to the fluid reservoir 10 through T-joint 46.

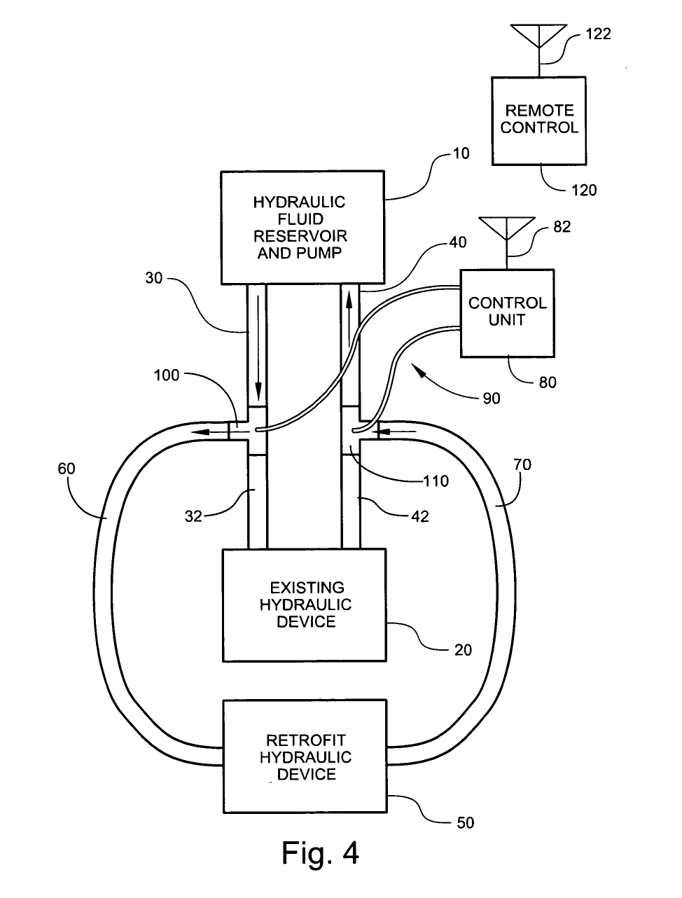

The user can operate device 20 or device 50 by controlling valves 38, 48, 64, 74 with control unit 80. The control unit 80 may be connected to the valves 38, 48, 64, 74 by electrical wires 90. The control unit 80 may also receive signals from a remote control (as shown in FIG. 4) so that the user can open and close the valves 38, 48, 64, 74 wirelessly, for example by a radio signal.

The primary hydraulic device 20, for example, may be a boom arm with a grapple, and the secondary hydraulic device 50 may be a grapple saw. In this example, the hydraulic system powers the boom arm 20 to move into a desired position. When in position and while the grapple is grasping the object to be cut, valves 38, 48 may be closed by the control unit 80, locking fluid in the lines in order to maintain pressure in the boom arm 20 and keep the arm 20 in the desired position and maintain the grasp of the grapple on the object to be cut. Then the valves 64, 74 in the secondary lines may be opened by the control unit 80 so that fluid may be pumped from the reservoir 10 to the grapple saw 50. The fluid pumped to the grapple saw 50 through T-joint 36 and returned to the reservoir 10 through T-joint 46 powers the grapple saw 50 to cut trees.

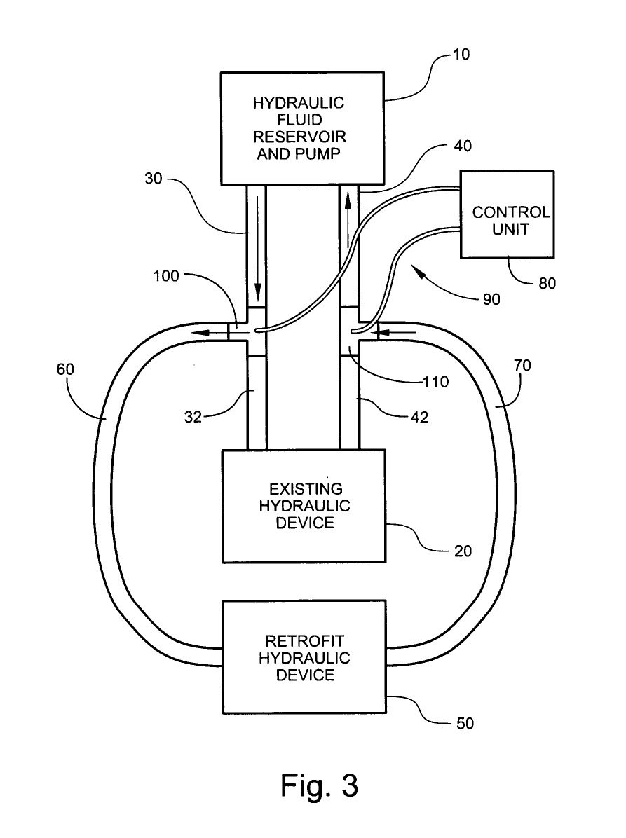

FIG. 3 is a schematic diagram of another embodiment of this invention, utilizing T-couplings or T-joints 100, 110 that each contain a valve that directs flow to either the primary device 20 or the secondary device 50. When such valves are incorporated in the T-joint 100, 110, the existing hydraulic lines have to be broken in only one place, rather than two, and only one pair of valve control lines or links are required for the secondary device 50. For example, the infeed to the primary device 20 requires only two lines 30, 32 connected at T-joint 100 and the outfeed from the primary device 20 requires only lines 40, 42 connected at T-joint 110. Similarly, the infeed for the secondary device 50, requires only line 60 and the outfeed for the secondary device 50 requires only line 70. As described above, the valves in T-joints 100, 110 are controlled by a control unit 80, either by a signal sent through electrical wires 90 or by a signal sent wirelessly, for example via a radio signal.

FIG. 4 is a schematic diagram of an embodiment of this invention, having wireless controls for the valves incorporated in T-joints 100 and 110. In this embodiment, the control unit 80 is connected to the valves by wires, but the user may control the valves by a remote control 120. The remote control 120 sends signals to the control unit by transmitting radio signals through antenna 122. The radio signals are received by the control unit 80 at antenna 82. This configuration allows the electrical wires 90 that connect the control unit 80 to the valves incorporated in T-joints 100 and 110 to be relatively short and allows the user to stand a safe distance away from the devices while controlling the valves.

While the examples shown in FIGS. 2, 3, and 4 have either two or four valves, it is possible to use just one valve. For example, the existing hydraulic device may contain one electric over hydraulic six-port selector valve that controls the flow of hydraulic fluid to all hydraulic lines. The valve is electrically actuated, as described above, by a control unit containing an antenna to receive radio signals from a remote control. The valve has six ports, but only four are needed for this embodiment, one each for the primary infeed, secondary infeed, primary outfeed, and secondary outfeed. The use of this valve further reduces the number of hydraulic lines that are required to attach the second device to the existing device. For example, the six-port double selector hydraulic valve (Model DS) manufactured by Metro Machine & Engineering Corp may be used. Other suitable valves may also be used to achieve this result.

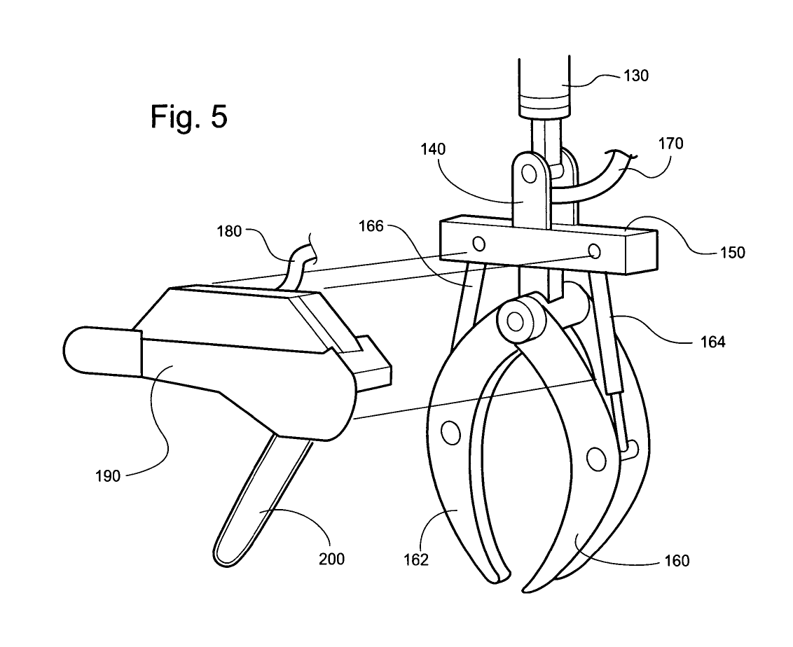

FIG. 5 shows an example of the present invention, wherein the secondary hydraulic device is a saw (such as the Riley Manufacturing Grapple Saw model number GS 390) and the existing hydraulic device is a grapple and boom. The grapple body 150 is connected to the boom 130 by a universal joint 140. The grapple arms 160, 162 are pivotally connected to the universal joint 140. The grapple arms 160, 162 are connected to the grapple body 150 by actuators 164, 166, which expand and contract longitudinally to position the grapple arms 160, 162. The movement of the grapple arms 160, 162 is powered by a hydraulic system, which according to the present invention is the existing hydraulic system. The infeed and outfeed hydraulic lines for the grapple are shown as contained in a single protective casing 170, which extends back to the hydraulic reservoir and pump (not shown). The valve for connecting the secondary hydraulic device can be located anywhere that is convenient. In this illustration, the valve is hidden within the universal joint 140.

The saw 200 is contained within a saw body 190, which can be bolted to the grapple body 150 for convenient use. The saw body 190 may also be attached to the grapple body 150 in any other suitable manner. The motor (not shown) of the saw 200 is connected to the grapple hydraulic lines by secondary hydraulic lines, as described above. Again, as shown, both the infeed and outfeed hydraulic lines for the saw motor are contained within a protective casing 180.

Although this illustration describes a saw connected to a grapple and boom, this invention can be used to connect any suitable secondary hydraulic device to an existing hydraulic device.

The foregoing description of illustrative embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

1. A hydraulic apparatus for attachment to a first hydraulically actuated device having a first valve connected within a supply hydraulic line and a second valve connected within a return hydraulic line, the apparatus comprising:
a second hydraulically actuated device connected to the first valve by a first supplemental hydraulic line and connected to the second valve by a second supplemental hydraulic line, the first supplemental hydraulic line adapted to supply hydraulic fluid to the second device, and the second supplemental hydraulic line adapted to return hydraulic fluid from the second device to a fluid reservoir of the first device,
wherein the first valve is operable to divert hydraulic fluid flow from the first hydraulic device to the second hydraulic device while maintaining a supply fluid pressure in the first hydraulic device, and
wherein the second valve is operable to allow hydraulic fluid flow from the second device to the fluid reservoir while maintaining a fluid return pressure in the first hydraulic device.

2. The apparatus of claim 1, wherein each valve is electromechanically activated.

3. The apparatus of claim 2, wherein each valve is electrically controlled by cable.

4. The apparatus of claim 2, wherein each valve is wirelessly controlled.

5. The apparatus of claim 1, wherein the first device is a grapple and the second device is a grapple saw.

6. A hydraulic apparatus for attachment to a first hydraulically actuated device having a valve with at least four ports, the apparatus comprising:
a second hydraulically actuated device connected to the valve by a first supplemental hydraulic line and connected to the valve by a second supplemental hydraulic line, the first supplemental hydraulic line adapted to supply hydraulic fluid to the second device, and the second supplemental hydraulic line adapted to return hydraulic fluid from the second device to a fluid reservoir of the first device,
wherein the valve is operable to divert hydraulic fluid flow from the first hydraulic device to the second hydraulic device while maintaining a supply fluid pressure in the first hydraulic device, and
wherein the valve is operable to allow hydraulic fluid flow from the second device to the fluid reservoir while maintaining a fluid return pressure in the first hydraulic device.

7. The apparatus of claim 6, wherein the valve is electromechanically activated.

8. The apparatus of claim 7, wherein the valve is electrically controlled by cable.

9. The apparatus of claim 7, wherein the valve is wirelessly controlled.

10. The apparatus of claim 6, wherein the first device is a grapple and the second device is a grapple saw.

11. A method of retrofitting a second hydraulic device to a first hydraulic device comprising:
inserting a valve having at least four ports into a first hydraulic device;
connecting a first supply hydraulic line of the first device to a first port of the valve;
connecting a first return hydraulic line of the first device to a second port of the valve;
connecting a second supply hydraulic line of a second hydraulic device to a third port of the valve;
connecting a second return hydraulic line of the second hydraulic device to a fourth port of the valve;
wherein the valve is operable to divert hydraulic fluid flow from the first hydraulic device to the second hydraulic device while maintaining a supply fluid pressure in the first hydraulic device, and
wherein the valve is operable to allow hydraulic fluid flow from the second device to the fluid reservoir while maintaining a fluid return pressure in the first hydraulic device.

12. The method of claim 11, further comprising actuating the valve electromechanically.

13. The method of claim 12, further comprising controlling the valve electrically by cable.

14. The method of claim 12, further comprising controlling the valve wirelessly.

15. The method of claim 11, wherein the first device is a grapple and the second device is a grapple saw.
